(19) United States
(12) Patent Application Publication
(10) Pub. No.: US 2009/0115331 A1
(43) Pub. Date: May 7, 2009

(54) PLASMA DISPLAY DEVICE

(75) Inventors: Hiroshi KUNIMOTO, Osaka (JP); Hirotsugu FUSAYASU, Kyoto (JP); Kei ICHIKAWA, Osaka (JP); Seiji HAMADA, Osaka (JP); Ryo MATSUBARA, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Kadoma-shi (JP)

(21) Appl. No.: 12/255,156

(22) Filed: Oct. 21, 2008

(30) Foreign Application Priority Data
Nov. 7, 2007 (JP) 2007-289467

(51) Int. Cl. H01J 17/49

(52) U.S. Cl. 313/582

(57) ABSTRACT

The present invention provides a plasma display device capable of maintaining an electromagnetic wave shielding effect. The plasma display device includes an optical filter having a conductive film, a frame supporting the periphery of the optical filter, a conductive member fixed to the frame, and a conductive back cover with the periphery thereof being contacted with the conductive member. Flexible conductive connecting portions are provided on the periphery of the conductive film, and the connecting portions are connected electrically, in a slack state, to the conductive member, and thereby the conductive film and the conductive member are connected electrically to each other.

### BACKGROUND OF THE INVENTION

1. Field of the Invention

The present invention relates to a plasma display device including a plasma display panel (hereinafter referred to as a “PDP”).

2. Related Background Art

Conventionally, plasma display devices are designed to enclose a PDP with a conductive member in order to block unnecessary radiation of electromagnetic waves emitted from the PDP. For example, JP 10(1998)-322625 A discloses a plasma display device 10 configured as shown in FIG. 11. This plasma display device 10 includes: an optical filter 12 disposed at the front side of a PDP 11 and having a conductive film 12a and a transparent substrate 12b; a frame 13 supporting the periphery of the optical filter 12; and a conductive back cover 15 disposed at the rear side of the PDP 11.

A conductive layer 14 is formed on the frame 13. The periphery of the back cover 15 is fixed to the frame 13, and thereby the periphery thereof is in contact with the conductive layer 14. The frame 13 also is provided with a hook-like retaining portion 13a for retaining the optical filter 12 at the side of the transparent substrate 12b, and a plate spring portion 13b for biasing the optical filter 12 from the side of the conductive film 12a so as to push the optical filter 12 against the retaining portion 13a. Thus, the optical filter 12 is caught between the plate spring portion 13b and the retaining portion 13a. The conductive layer 14 also is formed on the surface of the plate spring portion 13b. The conductive layer 14 is pressed against the conductive film 12a owing to the biasing force applied by the plate spring portion 13b, so that the conductive layer 14 and the conductive film 12a are connected electrically to each other.

However, in the plasma display device 10 configured as described above, when vibrations or the like cause a relative displacement between the frame 13 and the optical filter 12, the conductive layer 14 formed on the surface of the plate spring portion 13b and the conductive film 12a rub against each other and the friction between them damages their contact surfaces, which may cause poor contact between them or increase the contact resistance. As a result, the electromagnetic wave shielding effect may be deteriorated.

### SUMMARY OF THE INVENTION

In view of these circumstances, it is an object of the present invention to provide a plasma display device capable of maintaining an electromagnetic wave shielding effect.

In order to achieve the above object, the present invention provides a plasma display device including: a plasma display panel (PDP); an optical filter disposed at a front side of the PDP and having a conductive film; a frame supporting a periphery of the optical filter; a conductive member fixed to the frame; and a conductive back cover disposed at a rear side of the PDP, with a periphery thereof being contacted with the conductive member. In this plasma display device, flexible conductive connecting portions are provided on a periphery of the conductive film, and the connecting portions are connected electrically, in a slack state, to the conductive member, and thereby the conductive film and the conductive member are connected electrically to each other.

It should be noted that the phrase “in a slack state” means that the connecting portion is not pulled tight because it has an allowance in length and is longer enough to be connected to the conductive member.

According to the configuration as described above, the flexible connecting portions provided on the periphery of the conductive film are connected to the conductive member. Therefore, even if a relative displacement occurs between the frame and the optical filter due to vibrations or the like, the connecting portions merely are deformed and thus the connecting portions and the conductive member are prevented from rubbing against each other. In addition, since the connecting portions are in a slack state, the possibility that the connecting portions are damaged is reduced even if it is pulled along with a movement of the optical filter. Accordingly, the present invention makes it possible to maintain a good electrical connection between the conductive film and the conductive member, and thus to maintain the electromagnetic wave shielding effect.

### BRIEF DESCRIPTION OF THE DRAWINGS

FIG. 1 is an exploded cross-sectional view of a plasma display device according to a first embodiment of the present invention;

FIG. 2 is a front view of an optical filter to be used for the plasma display device shown in FIG. 1;

FIG. 3 is a cross-sectional view of the optical filter shown in FIG. 2;

FIG. 4 is an exploded cross-sectional view of a plasma display device according to a second embodiment of the present invention;

FIG. 5 is a front view of an optical filter to be used for the plasma display device shown in FIG. 4;

FIG. 6 is a cross-sectional view of the optical filter shown in FIG. 5;

FIG. 7 is an exploded cross-sectional view of a plasma display device according to a third embodiment of the present invention;

FIG. 8 is a front view of an optical filter to be used for the plasma display device shown in FIG. 7;

FIG. 9 is a cross-sectional view of the optical filter shown in FIG. 8;

FIG. 10 is an exploded cross-sectional view of a plasma display device according to a fourth embodiment of the present invention; and

FIG. 11 is an exploded cross-sectional view of a conventional plasma display device.

### DETAILED DESCRIPTION OF THE INVENTION

Hereinafter, the preferred embodiments for carrying out the present invention will be described with reference to the accompanying drawings. It should be noted, however, that the embodiments described below are merely exemplary of the present invention, and should not be construed to limit the scope of the present invention.

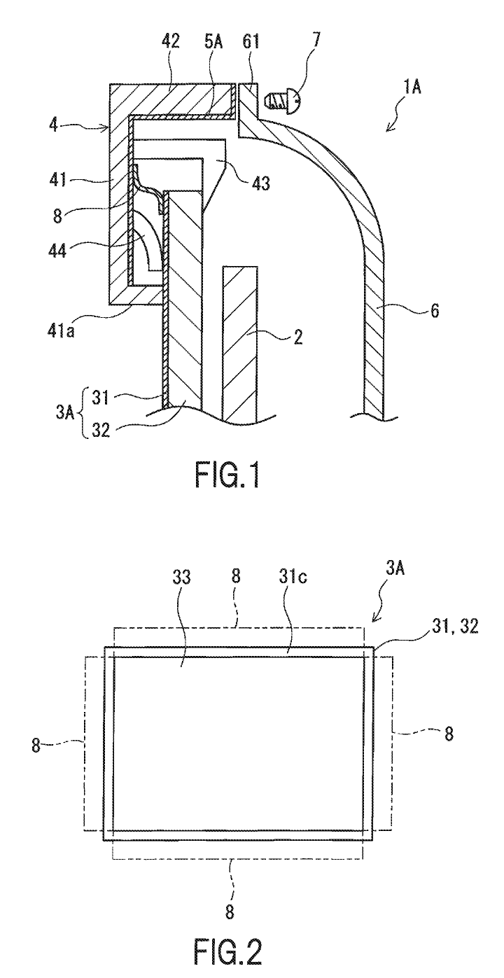

FIG. 1 shows a plasma display device 1A according to a first embodiment of the present invention. This plasma display device 1A includes a PDP 2, an optical filter 3A disposed at the front side of the PDP 2, a frame 4 supporting the periphery of the optical filter 3A, and a back cover 6 disposed at the rear side of the PDP 2.

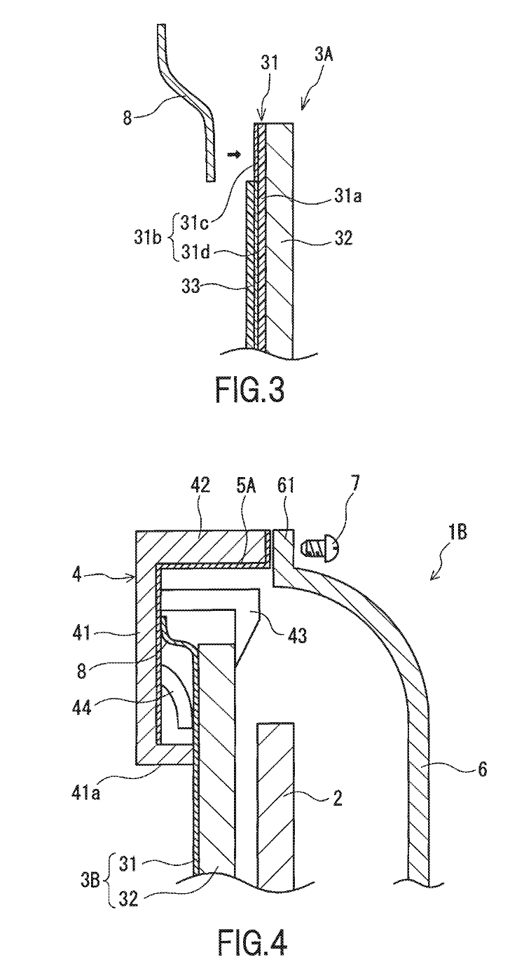

The optical filter 3A has a rectangular transparent substrate 32 made of glass or resin such as acrylic resin, and a conductive film 31 attached to approximately the entire front surface of the transparent substrate 32 located at the opposite side to the PDP 2 and thereby held by the transparent substrate 32. As shown in FIGS. 2 and 3, the conductive film 31 has a base layer 31a made of a polyester film or the like and deposited on the transparent substrate 32, and a conductive layer 31b formed on the base layer 31a. The conductive layer 31b is made of a metal such as copper. The periphery of the conductive layer 31b is formed of a metal foil 31c, and a portion surrounded by the metal foil 31c is a metal mesh 31d. The metal mesh 31d of the conductive layer 31b is covered with a protective layer 33 made of a transparent insulating resin.

The frame 4 is made of resin, for example. The frame 4 has a rectangular frame shape as viewed from the front, and has four sides each having an approximately L-shaped cross-section. Specifically, the frame 4 has a front plate 41 forming a window 41a and covering the periphery of the optical filter 3A from the front side thereof, and a peripheral wall 42 extending from the peripheral edge of the front plate 41 toward the rear side. The front plate 41 is provided with a hook-like retaining portion 43 for retaining the optical filter 3A at the side of the transparent substrate 32, and a plate spring portion 44 for biasing the optical filter 3A from the side of the conductive film 31 so as to push the optical filter 3A against the retaining portion 43. Thus, the optical filter 3A is caught between the plate spring portion 44 and the retaining portion 43.

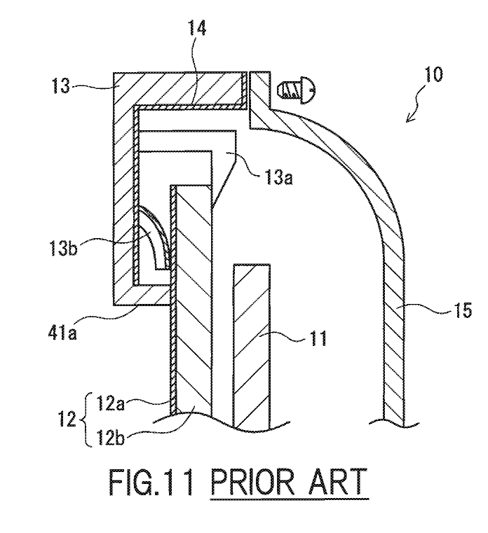

A conductive layer (a conductive member) 5A is attached firmly to the frame 4. This conductive layer 5A may be formed by applying a conductive material to the frame 4 and curing the material. Specifically, the conductive layer 5A is formed on the back surface of the front plate 41 as well as the inner surface and the end surface of the peripheral wall 42. Unlike the conventional configuration as described in the Related Background Art (the configuration as shown in FIG. 11), the conductive layer 5A need not be formed on the surface of the plate spring portion 44 in the present embodiment.

The back cover 6 is a conductive cover obtained by pressing a metal plate into the desired shape. The periphery 61 of the back cover 6 is fixed to the end surface of the peripheral wall 42 of the frame 4 with screws 7, so that the periphery 61 is brought into contact with the conductive layer 5A to be connected to the conductive layer 5A electrically.

Furthermore, in the present embodiment, four connecting portions 8 are provided on the periphery of the conductive film 31, as shown in FIG. 2. These connecting portions 8 project upward and downward, and leftward and rightward from the transparent substrate 32 in FIG. 2. The connecting portions 8 are long films extending along the respective sides of the conductive film 31 and have flexibility. These connecting portions 8 may be made of a metal foil such as copper and aluminum or a conductive tape and thus have conductivity. The connecting portions 8 are joined to the metal foil 31c of the conductive layer 31b with a conductive adhesive or the like so as to be connected to the conductive layer 31b electrically. In view of ease of removal for repair, it is preferable to use a conductive tape. When the conductive tape is used, not the adhesive surface covered with a separator but the back surface thereof on which the metal foil is exposed is joined to the conductive layer 31b.

As shown in FIG. 1, the end portion of each connecting portion 8 is joined, with a conductive adhesive or the like, to a portion of the conductive layer 5A located on the back surface of the front plate 41 of the frame 4 in such a manner that the connecting portion 8 is connected, in a slack state, to the conductive layer 5A. Thereby, the conductive film 31 and the conductive layer 5A are connected electrically to each other. As described above, the end portion of each connecting portion 8 can be joined to the conductive layer 5A in the following manner. When the conductive tape is used as the connecting portion 8, the separator is first removed. Then, the optical filter 3A is pushed into a gap between the plate spring portion 44 and the retaining portion 43 of the frame 4 while the retaining portion 43 is deformed elastically toward the peripheral wall 42. After that, the connecting portion 8 is pressed against the conductive layer 5A with a plate or the like through a gap between the transparent substrate 32 and the peripheral wall 42. The retaining portion 43 may be designed to be removable from the front plate 41 of the frame 4 with a screw member or in an engagement structure. In this case, the retaining portion 43 may be fixed to the front plate 41 after the optical filter 3A is placed on the plate spring portion 44.

As described above, in the plasma display device 1A of the present embodiment, the flexible connecting portions 8 provided on the periphery of the conductive film 31 are connected to the conductive layer 5A. Therefore, even if a relative displacement occurs between the frame 4 and the optical filter 3A due to vibrations or the like, the connecting portions 8 merely are deformed, and the connecting portions 8 and the conductive layer 5A are prevented from rubbing against each other. In addition, since the connecting portions 8 are in a slack state, the possibility that the connecting portions 8 are damaged is reduced even if they are pulled along with a movement of the optical filter 3A. Accordingly, the present invention makes it possible to maintain a good electrical connection between the conductive film 31 and the conductive layer 5A, and thus to maintain the electromagnetic wave shielding effect.

In addition, since the conductive film 31 is attached to the front surface of the transparent substrate 32 located at the opposite side to the PDP 2, a longer distance can be secured between the PDP 2 and the conductive film 31 by the thickness of the transparent substrate 32. Thus, the accumulation of electric charges on the conductive film 31 can be reduced.

The connecting portion 8 extending along each side of the transparent substrate 32 does not need to be a single sheet. It may be divided into several sheets in the longitudinal direction thereof.

Next, a plasma display device 1B according to a second embodiment of the present invention will be described with reference to FIGS. 4 to 6. In the second embodiment as well as the third and fourth embodiments to be described later, the same components as those in the first embodiment are designated by the same reference numerals, and the description thereof is not repeated.

The plasma display device 1B of the second embodiment basically has the same configuration as that of the plasma display device 1A of the first embodiment, except that the connecting portions 8 are formed integrally with the conductive film 31. In an optical filter 3B of the second embodiment, the conductive film 31 projects upward and downward, and leftward and rightward from the transparent substrate 32 in FIG. 5, and these projecting portions constitute the connecting portions 8. Specifically, the base layer 31a and the metal foil 31c are extended outwardly from the transparent substrate 32 by a predetermined length and with widths corresponding to respective sides of the transparent substrate 32, and these extended portions of the base layer 31a and the metal foil 31c constitute the connecting portions 8. In other words, the conductive film 31 has a rectangular shape with the four corners cut, and the widths of the respective connecting portions 8 (lengths in the directions along the respective sides of the transparent substrate 32) match the lengths of the respective sides of the transparent substrate 32. The widths of the respective connecting portions 8 may be set slightly smaller than the lengths of the respective sides of the transparent substrate 32. Similarly to the first embodiment, the end portion of each connecting portion 8 is joined to the conductive layer 5A with a conductive adhesive or the like so that the connecting portion 8 is connected, in a slack state, to the conductive layer 5A.

In the plasma display device in which the connecting portions 8 are formed integrally with the conductive film 31 as described above, the same advantageous effects can be obtained as in the first embodiment while reducing the parts count.

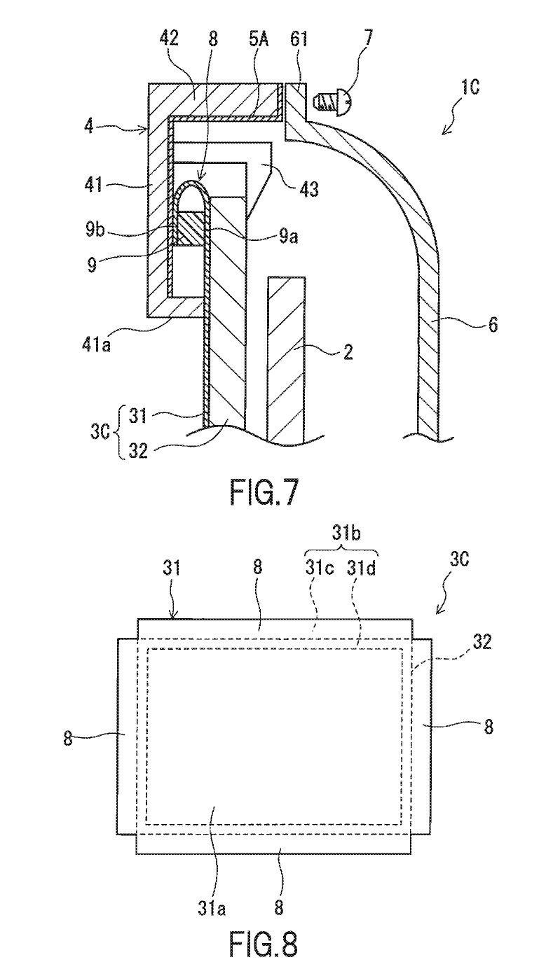

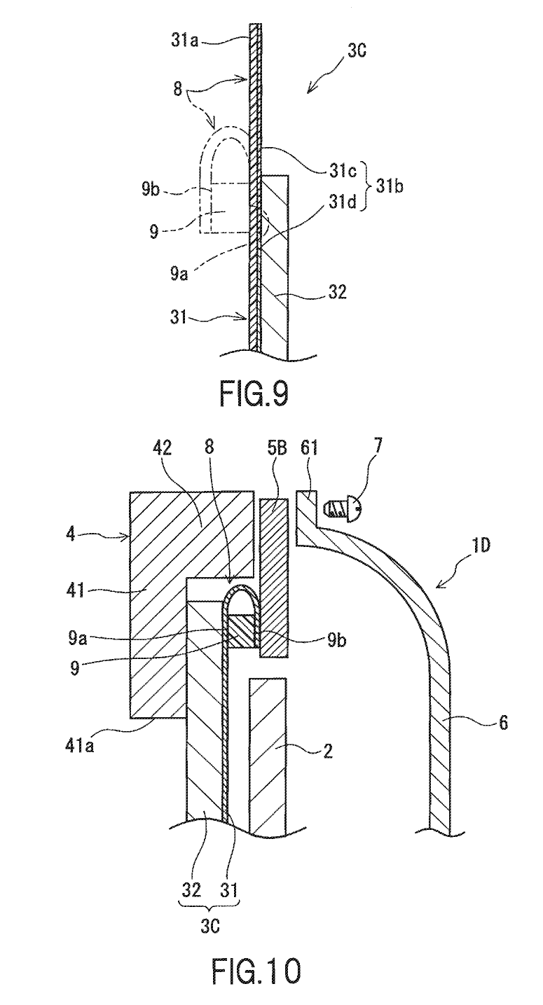

Next, a plasma display device 1C according to a third embodiment of the present invention will be described with reference to FIGS. 7 to 9. In the plasma display device 1C of the third embodiment, the plate spring portion 44 (see FIG. 1) is not provided on the frame 4, but instead, an elastic member 9 is disposed between the optical filter 3C and the conductive layer 5A. The optical filter 3C is pushed against the retaining portion 43 by this elastic member 9.

The elastic member 9 is a rod-shaped member having a rectangular cross-section, and is arranged on the conductive film 31 in a frame shape along the profile of the transparent substrate 32 in such a manner that the conductive film 31 is interposed between the elastic member 9 and the transparent substrate 32. Materials for this elastic member 9 are not particularly limited. Examples of the materials include rubber, polyurethane foam, and expanded polystyrene.

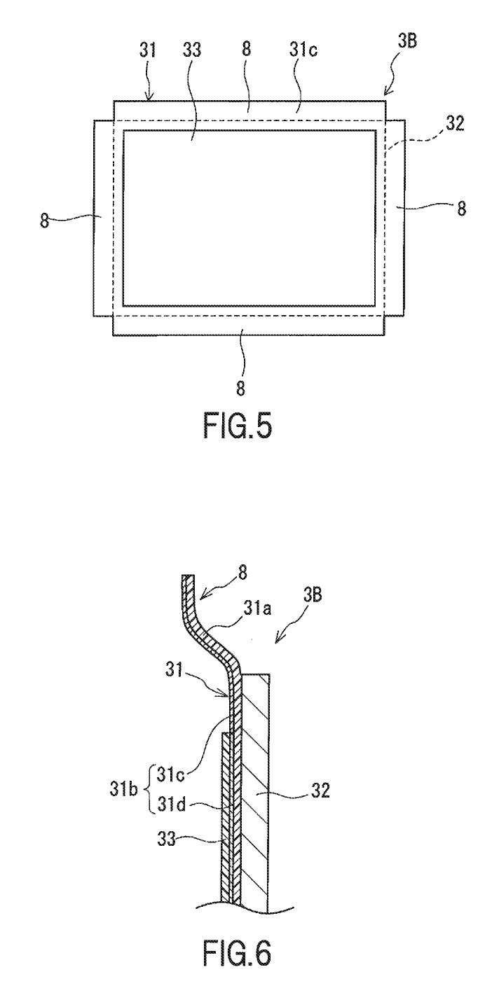

Furthermore, in the optical filter 3C of the third embodiment, the conductive film 31 has the same shape as that of the second embodiment, but it is attached to the transparent substrate 32 in a reversed manner in the third embodiment. Specifically, in the second embodiment, the conductive film 31 is attached to the transparent substrate 32 with the base layer 31a being directly contacted with the transparent substrate 32, whereas in the third embodiment, the conductive film 31 is attached to the transparent substrate 32 with the conductive layer 31b being directly contacted with the transparent substrate 32. In addition, in the third embodiment, a protective layer 33 (see FIG. 6) is not provided.

Furthermore, in the third embodiment, each of the connecting portions 8 formed integrally with the conductive film 31 is folded away from the transparent substrate 32 and caught between the conductive layer 5A and the elastic member 9. Thereby, the connecting portions 8 are connected electrically, in a slack state, to the conductive layer 5A. The connecting portions 8 are joined to the elastic member 9 but are not joined to the conductive layer 5A. The connecting portions 8 are pushed against the conductive layer 5A by an elastic repulsive force of the elastic member 9. In order to achieve this configuration, the undersurface 9a of the elastic member 9 is first bonded to the conductive film 31 with a double-sided tape or the like. Then, the folded connecting portion 8 is bonded to the top surface 9b of the elastic member 9 with a double-sided tape or the like. After that, the optical filter 3C may be engaged in the retaining portion 43 while the elastic member 9 is deformed elastically so that its top surface 9b and undersurface 9a come closer to each other.

With such a configuration, not only the same advantageous effects as provided by the first embodiment can be obtained, but also the connecting portions 8 can be connected to the conductive layer 5A by utilizing the elastic repulsive force of the elastic member 9. When a relative displacement occurs between the frame 4 and the optical filter 3C, in the second embodiment, the surface of the optical filter 3B at the side of the conductive film 31 (i.e., the surface of the protective layer 33 in the second embodiment) may be damaged by the plate spring portion 44. On the contrary, in the third embodiment, since the optical filter 3C is pushed against the retaining portion 43 by the elastic member 9, the elastic member 9 is deformed transversely along with the movement of the optical filter 3C, even if the frame 4 and the optical filter 3C are displaced relative to each other. Thus, the surface of the optical filter 3C is never damaged.

Furthermore, in the third embodiment, the conductive film 31 is attached to the transparent substrate 32 with the conductive layer 31b being directly contacted with the transparent substrate 32. The conductive layer 31b can be protected by the base layer 31a, which eliminates the need of the protective layer 33 as shown in FIG. 6.

Next, a plasma display device 1D according to a fourth embodiment of the present invention will be described with reference to FIG. 10. Although the same optical filter 3C as that of the third embodiment is used in the plasma display device 1D of the fourth embodiment, the optical filter 3C is oriented in a different direction. In the fourth embodiment, the optical filter 3C is disposed in such a manner that the conductive film 31 faces the PDP 2. In other words, the conductive film 31 is attached to the rear surface of the transparent substrate 32 at the side of the PDP 2.

In the fourth embodiment, the periphery of the optical filter 3C is supported by the front plate 41 of the frame 4 at the side of the transparent substrate 32. In other words, in the fourth embodiment, the front plate 41 serves as a retaining portion for retaining the optical filter 3C at the side of the transparent substrate 32.

Furthermore, in the fourth embodiment, a frame-shaped conductive pressing metal member 5B is provided instead of the conductive layer 5A (see FIG. 7). This pressing metal member 5B is fixed, together with the periphery 61 of the back cover 6, to the end surface of the peripheral wall 42 of the frame 4 with screws 7 and thereby surface-contacted with the periphery 61 of the back cover 6, so as to be connected electrically to the back cover 6. At the same time, the pressing metal member 5B presses the periphery of the optical filter 3C against the front plate 41 of the frame 4 via the elastic member 9. In addition, each of the connecting portions 8 that is folded away from the transparent substrate 32 is bonded to the top surface 9b of the elastic member 9. Thus, when the pressing metal member 5B is fixed with the screws 7 as described above, the connecting members 8 are caught between the elastic member 9 and the pressing metal member 5B.

Even with this configuration, the same advantageous effects as provided by the third embodiment can be obtained, except that a longer distance cannot be secured between the PDP 2 and the conductive film 3C by the thickness of the transparent substrate 32.

What is claimed is:

1. A plasma display device comprising:
a plasma display panel;
an optical filter disposed at a front side of the plasma display panel and having a conductive film;
a frame supporting a periphery of the optical filter;
a conductive member fixed to the frame; and
a conductive back cover disposed at a rear side of the plasma display panel, with a periphery thereof being contacted with the conductive member,
wherein flexible conductive connecting portions are provided on a periphery of the conductive film, and the connecting portions are connected electrically, in a slack state, to the conductive member, and thereby the conductive film and the conductive member are connected electrically to each other.

2. The plasma display device according to claim 1,
wherein the optical filter has a transparent substrate holding the conductive film, the conductive film projects from the transparent substrate, and the projecting portions constitute the connecting portions, respectively.

3. The plasma display device according to claim 2,
wherein the frame has a retaining portion for retaining the optical filter at a side of the transparent substrate,
an elastic member for pushing the optical filter against the retaining portion is disposed between the optical filter and the conductive member, and
the connecting portions are folded away from the transparent substrate and caught between the conductive member and the elastic member.

4. The plasma display device according to claim 2,
wherein the conductive film is attached to a surface of the transparent substrate located at an opposite side to the plasma display panel.

5. The plasma display device according to claim 2,
wherein the conductive film is attached to a surface of the transparent substrate located at a side of the plasma display panel.

6. The plasma display device according to claim 4,
wherein the conductive member is a conductive layer formed on the frame.

7. The plasma display device according to claim 5,
wherein the conductive member is a pressing metal member for pressing a periphery of the optical filter against the frame.
